(19) United States
(12) Patent Application Publication
(10) Pub. No.: US 2003/0176570 A1
(43) Pub. Date: Sep. 18, 2003

(54) Method of making polymeric polymers

(76) Inventors: Dennis E. Smith, Rochester, NY (US); James R. Bennett, Rochester, NY (US); Larry D. Hagemeier, Rochester, NY (US)

Correspondence Address: Paul A. Leipold, Patent Legal Staff, Eastman Kodak Company, 343 State Street, Rochester, NY, 14650-2201, US

(21) Appl. No.: 10/095,389

(22) Filed: Mar. 12, 2002

(51) Int. Cl. C08L 1/00

(52) U.S. Cl. 524/804

(57) ABSTRACT

A method of preventing the agglomeration of particles surrounded by a particulate suspension stabilizing agent which comprises providing an aqueous suspension of particles surrounded by a particulate suspension stabilizing agent and adding to the aqueous medium a polyanion.

### FIELD OF THE INVENTION

This invention relates to the preparation of polymer particles using the limited coalescence technique. More particularly, the invention concerns a limited coalescence method of making polymer particles of controlled size in which the formation of particle agglomerates is substantially eliminated or avoided.

### BACKGROUND

In many applications for polymer particles it is very important for such particles to have a narrow size distribution. Such polymer particles are very useful matting agents, opacifying agents and spacers, particularly in photographic, thermal imaging and electrostatographic materials such as toners and carriers. For example, U.S. Pat. Nos. 4,994,312 and 5,055,371 describe the use of small polymer particles to provide voids in polymeric shaped articles such as polyester sheets. Such sheets exhibit unique properties, including texture, opacity and whiteness which make them particularly suitable photographic supports and receiver sheets for electrostatic toner images.

The preparation of polymeric particles having controlled average particle size and narrow size distribution by a technique that has become known as “limited coalescence” is described in several patents including, for example, the aforementioned U.S. Pat. Nos. 4,994,312 and 5,055,371 and U.S. Pat. Nos. 2,932,629; 2,934,530; 4,833,060; 4,835,084; 4,965,131; 5,378,577; 5,288,598; and 5,354,799.

In the limited coalescence method, as illustrated by the aforementioned patents, polymer particles are prepared by forming an aqueous suspension of polymer droplets in a medium containing small particles of a solid stabilizer to form droplets having a layer of such solid stabilizer particles on their surfaces (often referred to as an oil phase) in the aqueous medium (aqueous phase), forming solid polymer particles from the droplets and recovering the polymer particles. During the course of the process, coalescence of the oil (discontinuous) phase takes place to form larger size droplets. These droplets are limited in size by the presence of the particles of the solid stabilizer (often referred to as a suspension stabilizer or suspension stabilizing agent) in the aqueous (continuous) phase. The solid stabilizer particles limit coalescence from taking place by a mechanism that is generally believed to be a physical phenomenon of preventing, by physical separation, one droplet from wetting another and thereby joining together to form a larger droplet. Solid polymer particles that are covered with a layer of smaller stabilizer particles are formed from the droplets and recovered.

A problem that can occur in a limited coalescence method of making polymer particles of controlled size and size distribution is that such particles tend to agglomerate and form clumps of particles either in storage as an aqueous slurry or upon drying. The formation of such agglomerates defeats the purpose of utilizing the limited coalescence method in the first place to achieve a narrow particle size distribution.

In conventional prior art limited coalescence methods, it is accepted practice to prevent agglomeration by separating the polymer particles from the aqueous reaction medium in which they are prepared, for example, by collection on a fine mesh screen or filter, and then washing the separated particles, i.e., the filter cake, with water prior to storage as an aqueous slurry or drying. Suitable washing techniques include rinsing or spraying the filter cake with water, which is commonly known as displacement washing, or dispersing the filter cake in water, which is commonly known as reslurry washing, or diafiltration. Also known is washing with organic liquid diluents as disclosed in U.S. Pat. No. 5,354,799.

An aspect of this invention is to provide a method of making polymer particles using a limited coalescence method which avoids or substantially eliminates the formation of polymer particle agglomerates or clumps either in storage as an aqueous slurry or upon drying.

### SUMMARY OF THE INVENTION

Accordingly, this invention provides a method of preventing the agglomeration of particles surrounded by a particulate suspension stabilizing agent which comprises providing an aqueous suspension of particles surrounded by a particulate suspension stabilizing agent and adding to the aqueous medium a polyanion. By polyanion is meant surface active, water soluble, organic, polymeric materials having a weight average molecular weight greater than 500 and negatively charged ionizable groups.

A significant advantage of this invention is that it provides a convenient and cost effective means of modifying conventional limited coalescence methods which avoids or substantially eliminates the formation of particle agglomerates or clumps.

### DETAILED DESCRIPTION OF THE INVENTION

As previously indicated herein, this invention is an improvement in the limited coalescence method for preparing polymer particles. The limited coalescence method is well known to those skilled in the art and process parameters, except for the use of the polyanion according to the practice of this invention, are described in a number of patents, including U.S. Pat. No. 2,932,629, issued Apr. 12, 1960; U.S. Pat. No. 2,934,530, issued Apr. 26, 1960; U.S. Pat. No. 4,833,060, issued May 23, 1989; U.S. Pat. No. 4,835,084, issued May 30, 1989; U.S. Pat. No. 4,965,131, issued Oct. 23, 1990; U.S. Pat. No. 4,994,312, issued Feb. 19, 1992; and U.S. Pat. No. 5,055,371, issued Oct. 8, 1991, the disclosures of which are hereby incorporated herein by reference.

The limited coalescence method of this invention can differ in the technique used to form the suspension of polymer droplets, as discussed in detail, for example, in the aforementioned U.S. Pat. Nos. 4,835,084 and 4,965,131. The method employed in accordance with this invention encompasses the technique wherein monomer or monomers containing desired addenda are added to an aqueous suspension medium containing a particulate suspension stabilizer and, in certain cases, a promoter which drives the particulate suspension stabilizer to the surface of the monomer droplets. This mixture is agitated under heavy shearing forces to reduce the size of the droplets. During this time an equilibrium is reached and the size of the droplets is stabilized by the action of the suspension stabilizer coating the surfaces of the droplets. After polymerization is complete there is obtained a suspension of polymer particles in an aqueous phase having a layer of solid particulate suspension stabilizer on the surfaces of the polymer particles.

A second technique which is also encompassed by the limited coalescence method of this invention involves forming the polymer droplets by dissolving a polymer in a solvent therefor which solvent is immiscible with water thereby forming droplets in the continuous aqueous phase when the system is subjected to high shear agitation. The polymer particles in the aqueous phase are coated with the particulate suspension stabilizer in the same manner as described in the previous paragraph.

In the method in accordance with this invention the particles surrounded by a particulate suspension stabilizing agent to which the polyanion is added include, monomer droplets, droplets of polymer dissolved in the solvent, or solid polymer particles. The solid polymer particles can be suspended in the original aqueous medium, or separated from the original aqueous medium by washing and then resuspended.

In a limited coalescence method wherein polymerization takes place within the discontinuous monomer droplet particles, any suitable polymerizable monomer may be used in accordance with this invention. Typical polymerizable monomers are those that form linear addition polymers, typically by vinyl addition polymerization. Examples of suitable monomers are styrene, p-chlorostyrene; vinyl naphthalene; ethylenically unsaturated mono-olefins such as ethylene, propylene, butylene and isobutylene; vinyl acetate, vinyl propionate, vinyl benzoate, and vinyl butyrate; esters of alphamethylene aliphatic monocarboxylic acids such as methyl acrylate, ethyl acrylate, N-butylacrylate, isobutyl acrylate, dodecyl acrylate, n-octyl acrylate, 2-choroethyl acrylate, phenyl acrylate, methyl-alphachloroacrylate, methyl methacrylate, ethyl methacrylate and butyl methacrylate; acrylonitrile, methacrylonitrile, acrylamide, vinyl ethers such as vinyl methyl ether, vinyl isobutyl ether and vinyl ethyl ether; vinyl ketones such as vinyl methylketone, vinyl hexyl ketone and methyl isopropyl ketone; and N-vinyl compounds such as N-vinyl pyrrole, N-vinyl carbazole, N-vinyl indole and N-vinyl pyrrolidene; and mixtures thereof. Styrene, methylmethacrylate, divinylbenzene or mixtures thereof have been found to be particularly suitable monomers for use in the method of this invention.

If desired, other suitable crosslinking monomers may be used in forming polymer droplets by polymerizing a monomer or monomers within droplets in accordance with this invention to thereby modify the polymeric particle and produce particularly desired properties. Typical crosslinking monomers are aromatic divinyl compounds such as divinylbenzene, divinylnaphthalene or derivatives thereof; diethylene carboxylate esters and amides such as diethylene glycol methacrylate, diethylene glycol methacrylamide, diethylene glycol acrylate, and other divinyl compounds such as divinyl sulfide or divinyl sulfone compounds.

Any catalyst or initiator which is soluble in the particular monomer or monomers polymerized within the droplets may be utilized in the process of the invention. Typical initiators for polymerization are the peroxide and azo initiators. Among those found suitable for use in the process of the invention are 2,2′ azobis (2,4-dimethyl valeronitrile), lauroyl peroxide, benzoyl peroxide and the like which result in complete polymerization without leaving detrimental residual materials. Chain transfer agents may also be added to the monomer to control the properties of the polymer particles formed.

When a polymer or mixture of polymers is used as the starting material to form the polymer particles, any suitable polymer may be used such as, for example, olefin homopolymers and copolymers, such as polyethylene, polypropylene, polyisobutylene, and polyisopentylene; polyfluoroolefins, such as polytetrafluoroethylene and polyhexamethylene adipamide; polyhexamethylene sebacamide, and polycaprolactam; acrylic resins, such as polymethyl-methacrylate, polyacrylonitrile, polymethylacrylate, polyethylmethacrylate, and styrene-methylmethacrylate copolymers and ethylene-methyl acrylate copolymers, ethylene-ethyl methacrylate copolymers, polystyrene and copolymers thereof with unsaturated monomers mentioned previously, cellulose derivatives, such as cellulose acetate, cellulose acetate butyrate, cellulose propionate, cellulose acetate propionate, and ethyl cellulose; polyesters, such as polycarbonates; polyvinyl resins, such as polyvinyl chloride, copolymers of vinyl chloride and vinyl acetate, and polyvinyl butyral, polyvinyl alcohol, polyvinyl acetal, ethylene-vinyl acetate copolymers, ethylene-vinyl alcohol copolymers, and ethylene-allyl copolymers, such as ethylene-allyl alcohol copolymers, ethylene-allyl acetone copolymers, ethylene-allyl benzene copolymers, ethylene-allyl ether copolymers, and ethylene-acrylic copolymers; and polyoxymethylene, polycondensation polymers such as polyesters, polyurethanes, polyamides and polycarbonates.

The diameter of the polymer droplets, and hence the diameter of the polymer particles (average particle size), can be varied predictably in limited coalescence methods. This is accomplished by deliberate variation of the composition of the aqueous liquid dispersion to control the average particle size of the polymer particles. The average particle size of the polymer particles in a limited coalescence process is determined principally by the composition of the aqueous dispersion and the mechanical conditions, such as the degree of shear and agitation, as well known to those skilled in the art. Furthermore, by employing the same compositions and mechanical conditions, operations can be repeated or the scale of operation can be changed and substantially the same results can be obtained as regards the average particle size of the polymer particles prepared.

The particulate suspension stabilizers employed in the practice of this invention include any of the solid colloidal materials that are known in prior art to be suitable for this purpose. Such stabilizers provide a third phase because they are insoluble in both the aqueous suspension medium and in the suspended droplets. They are also nondispersible in the droplets, but wettable by the droplets. They are more hydrophilic than oleophilic, and more hydrophilic than the droplets, so that they can remain at the interface of the aqueous suspension medium and the suspended droplets. Such stabilizers can be inorganic materials such as metal salts or hydroxides or oxides or clays or can be organic materials such as starches, sulfonated crosslinked organic homopolymers and resinous polymers, as described, for example, in U.S. Pat. No. 2,932,629. Silica, as described in U.S. Pat. No. 4,833,060, and copolymers such as copoly(styrene-2-hydroxyethyl methacrylate-methyacrylic acid-ethylene glycol dimethacrylate), as described in U.S. Pat. No. 4,965,131, are examples of particularly desirable particulate suspension stabilizers that can be used in the practice of this invention.

It is known that some suspension stabilizers, for example silica, are used with promoters that are present in the aqueous suspension medium and drive the particulate suspension stabilizer to the interface between the aqueous layer and the polymer droplets formed during vigorous stirring of the system. When a promoter is used in the method of this invention, any suitable promoter that is water soluble and affects the hydrophilic/hydrophobic balance of the particulate suspension stabilizer in the aqueous suspension medium may be employed to drive the solid particulate suspension stabilizer particles to the polymer/solvent droplet/aqueous suspension medium interface. Suitable materials include, for example, sulfonated polystyrenes, alginates, carboxymethyl cellulose, tetramethyl ammonium hydroxide or chloride, diethylaminoethylmethacrylate, water-soluble complex resinous amine condensation products such as the water soluble condensation products of diethanol amine and adipic acid, a particularly suitable one of this type is poly(adipic acid-co-methylaminoethanol), water-soluble condensation products of ethylene oxide, urea and formaldehyde and polyethyleneimine. Also effective as promoters are gelatin, glue, casein, albumin and gluten. Nonionic materials such as methoxy cellulose can be used. Generally, the promoter is used in amounts of at least 0.2, often about 1 to 1.2 parts per 100 parts of aqueous solution.

It is sometimes desirable to add to the aqueous suspension a few parts per million of a water-soluble, oil-insoluble polymerization inhibitor which is effective to prevent the polymerization of monomer molecules that may diffuse into the aqueous suspension medium when the polymer droplets are prepared by polymerization. Suitable inhibitors are well known in the prior art as exemplified by U.S. Pat. Nos. 2,932,629 and 4,994,312. Suitable polymerization inhibitors include, for example, potassium dichromate and cupric sulfate pentahydrate.

In the process of this invention as outlined above, the particle surrounded by particulate suspension stabilizing agent can take the form of:

1. Ethylenically unsaturated monomer droplets.

2. The droplets of 1 after polymerization of said droplets.

3. Polymer dissolved in a suitable solvent.

4. The droplets of 3 after removal of the solvent.

5. Any of 1-4 above after washing, drying, or resuspending.

The polyanion may be added at any point of 1-5 above. It is not desirable to add the polyanion prior to the formation of the particles as defined as the particle size distribution, as determined by the limited coalescence method, would be affected.

By polyanion is meant surface active, water soluble, organic, polymeric materials having a weight average molecular weight greater than 500 and negatively charged ionizable groups. The negatively charged ionizable groups can be carboxylic acids, sulfonic acids, hydrolyzed acrylamides, sulfates, sulfonates, phosphates and the like which are well known in the art. (See, for example, Anionic Surfactants-Chemical Analysis, Ed. by Cross, J., Marcel Dekker, Inc., 1977). The number of negatively charged ionizable groups is not limited, but must be sufficient to import water solubility to the polyanion directly or enable solubilization in water via salt formation with a base.

For example, suitable polysulfonates include linear polymeric structures having pendant —SO₃H(or —SO₃) groups such as petroleum sulfonates, poly(styrene sulfonates), or poly(2-acrylamido-2-methylpropanesulfonic acid).

Suitable polyphosphonates include polymethylenephosphonates and other structures possessing ionizable —PO₃H₂ structures.

The polyanion can be the homopolymer of a monomeric anion, for example, the polyanion can be polyacrylic acid derived from polymerization of acrylic acid, or it can be a copolymer of one or more monomeric anions with one or more water-insoluble, hydrophobic monomers such as styrene, methylmethacrylate and the like.

Preferred are polyacrylates (I), where R═H, CH₃; n<100,000; and Y═OH, OCH₃, O⁻Na⁺, etc., or copolymers with compatible monomers, or polymaleates (II), where n<100,000 and Y═OH, O⁻Na⁺, or copolymers with compatible monomers such as styrene, acrylic acid, etc.

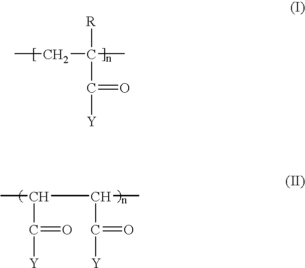

Especially preferred are salts of polymeric carboxylic acid with a molecular weight of about 5,000, such as Dispex N40 sold by Allied Colloids, Inc.

The amount of polyanion used in practice of this invention can vary widely. Factors such as the size of the particle, which effects its surface area, the amount of water in which the particle is suspended, the nature of the particulate suspension stabilizer, the particular polyanion employed, etc., effect the amount of polyanion which is required.

Typically, however, the polyanion used at between 0.05% and 10% of the weight of the particles and most preferably the polyanion used is between 1% and 5% of the weight of the particles, for this is all that is needed. Larger amounts, while permissible, and effective, would not normally be economically justified.

The invention will be further illustrated by the following examples:

### EXAMPLE 1

Polystyrene particles having an average size of about 9 μm are prepared as follows:

120 gm of 2,2′-azobis (2,4-dimethyl-valeronitrile) free radical initiator sold under the trade designation VAZO 52 by the DuPont Company is dissolved in 12,000 gm of styrene to provide a monomer solution.

An aqueous suspension is prepared from 20,000 gm of water, 2.6 gm of potassium dichromate, 175 gm of poly(adipic acid-co-2-methylaminoethanol) and 525 gm of a 50 percent aqueous dispersion of silica particles having a size of 20-25 nm sold under the trade name Ludox™ by the DuPont Company.

The monomer solution is added to the aqueous suspension and the resulting suspension is subjected to shear using a Crepaco homogenizer (sold by APV Gaulin, Inc.). This suspension is stirred at 50° C. in a 10 gallon stainless steel vessel for 16 hours. The temperature is then increased to 85° C. for 4 hours to harden the polystyrene particles and reduce residual monomer content. The polystyrene particles have a volume average particle size of about 9 μm. The suspension is cooled and poured through a standard 250 μm wire screen (60 mesh) to remove grossly oversize particles and agglomerates. The resulting suspension is poured into a large filter crock lined with nylon cloth sold under the trade name 3-3K300 MESH cloth by Tetko Inc. and filtered by vacuum to form a damp filter cake. The damp cake is washed with 20 gallons of water.

Approximately 50 gm of the damp cake is set aside (Sample 1). Approximately 50 gm of the damp cake is dried in a vacuum tray drier at 60° C. for 48 hours and 80° C. for 24 hours (Sample 2). Approximately 50 grams of the damp cake is slurried in solutions of 8 gm dispersant and 392 gm water for 1 hour, then filtered and dried like Sample 2.

Dispersants

| | |
|---|---|
| Sample 3 | Surfynol 82 Surfactant |
| (comparison) | (3,6-dimethyl-4-octyne-3,6-diol) |
| | sold by Air Products and Chemicals Inc., (nonionic) |
| Sample 4 | Polyvinylpyrolidone of molecular weight |
| (comparison) | 40,000 sold by Eastman Kodak Company |
| | Catalog No. 1370261 (nonionic) |
| Sample 5 | Dispex N40, a salt of a polymeric carboxylic acid in |
| | aqueous solution made by Allied Colloids Inc. |
| Sample 6 | Areosol OT 100% |
| (comparison) | Sodium dioctyl sulfosuccinate sold by American |
| | Cyanamid (anionic) |
| Sample 7 | Sodium Dodecyl Sulfate |
| (comparison) | C₁₂H₂₆O₄S sold by DuPont as Dupanol ME (anionic) |
| Sample 8 | Hexadecyltrimethylammonium bromide C₁₉H₄₂NBr, |
| (comparison) | Catalog No. 39, 697-4 |
| | Sigma-Aldrich (cationic) |

The eight samples are submitted for particle size analysis using a Coulter Counter Multisizer technique. Particles >20 μm are measured with and without sample sonification.

TABLE I

| | | PPM >20 μpm | |
|---|---|---|---|
| | | No Sonic | Sonic |
| Sample 1 | Damp cake | 1270 | 993 |
| Sample 2 | Damp cake dried no dispersant | 49765 | 445 |
| Sample 3 | Damp cake/Surfynol 82/ | 2239 | 1761 |
| | Dried | | |
| Sample 4 | Damp cake/PVP/Dried | 14222 | 1692 |
| Sample 5 | Damp cake/Dispex N40/Dried | 15 | 0 |
| Sample 6 | Damp cake/ | 18514 | 880 |
| | Aerosol/OT/Dried | | |
| Sample 7 | Damp cake/Dupanol ME/Dried | 1384 | 1156 |
| Sample 8 | Damp cake/ | 1289 | 993 |
| | C₁₉H₄₂NBr/Dried | | |

As shown by the values reported in the above Table I, the process of this invention significantly reduces particle agglomeration.

### EXAMPLE 2

In this example, Dispex N40 is added prior to polymerization.

The monomer solution contains 882 gm of styrene, 378 g of divinylbenzene and 12.6 g of VAZO 52.

The aqueous suspension contains 1,800 gm of water, 0.8 gm of potassium dichromate, 11.9 gm of poly(adipic acid-co-2-methylaminoethanol) and 180 g of Ludox™. The monomer solution is added to the aqueous suspension and the resulting suspension is homogenized. 500 mL of the suspension is reserved and the remainder is stirred at 50° C. in a 5 l. flask for 16 hours. The 50 mL of reserved suspension is poured into a 1 l. flask followed by a solution of 1000 g water and 10 g Dispex N40. The 1 l. flask is stirred at 50° C. for 16 hours. The temperature on both flasks is increased to 85° C. for 4 hours to harden the particles of polystyrene crosslinked with divinylbenzene having an average size of 4 μm. Both suspensions are cooled and the 5 l. flask is poured through a 100 mesh screen to remove oversize particles and agglomerates. The 1 l. flask containing Dispex N40 is not sieved at all. Both suspensions are vacuum filtered using buchner funnels lined with Tetko cloth to damp cakes. Both damp cakes are given a water displacement wash. The damp cake without Dispex N40 is split in half and half is given an additional methanol displacement wash. The treatments of the samples are summarized as follows:

Sample 1—Dispex added prior to polymerization, mother liquors removed, one displacement wash on the filter with water.

Sample 2—NO Dispex added, mother liquors removed, one displacement wash on the filter with water.

Sample 3—Sample 2 plus one displacement wash on the filter with methanol.

The samples are dried in an air oven at 80° C. for 64 hours.

| | | With |
|---|---|---|
| | | Sonifi-cation |
| | | ppm >20 μm |
| Sample 1 | Dispex added prior to polymerization, | 17 |
| | filtered, one water displacement wash | |
| Sample 2 | NO Dispex added | 57 |
| (comparison) | filtered, one water displacement wash | |
| Sample 3 | NO Dispex added | 58 |
| (comparison) | filtered, one methanol displacement wash | |

### EXAMPLE 3

Example 1, Sample 5, is repeated employing a polysulfonate (Versa TL sold by National Starch and Chemical Corp.) in place of the Dispex N40. Similar results are achieved for particles >20 μm.

The invention has been described in detail with particular reference to certain preferred embodiments thereof, but it will be understood that variations and modifications can be effected within the spirit and scope of the invention.

What is claimed is:

1. A limited coalescence method for preparing polymer particles comprising the steps of:
a) providing an aqueous medium suspension of ethylenically unsaturated monomers having a layer of solid particulate suspension stabilizing agent coated on the surfaces of said monomers;
b) polymerizing said monomers to form a polymer; and
c) adding to the aqueous medium a polyanion selected from the group consisting of a polyacrylate according to Formula I,
where R═H, CH₃; n<100,000; and Y═OH, OCH₃, O—Na+ 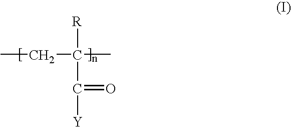
and a polymaleate according to formula (II) where n<100,000 and Y═OH, O⁻Na+

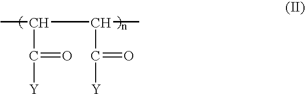

2. The method of claim 1 wherein the polyanion is present in an amount of from 0.05 to 10% of the weight of the particles.

3. The method of claim 2 wherein the polyanion is present in an amount of from 1 to 5% of the weight of the particles.

4. The method of claim 1 wherein the polymer is washed.

5. The method of claim 1 wherein the polymer is dried after adding the polyanion.

6. The method of claim 1 wherein the ethylenically unsaturated monomer is styrene, methylmethacrylate, divinylbenzene or mixtures thereof.

7. The method of claim 1 wherein the particulate suspension stabilizing agent is colloidal silica.

8. The method of claim 1 wherein step 3 is performed before step c.

9. The method of claim 1 wherein step c is performed after step b.
